(19) United States
(12) Patent Application Publication
(10) Pub. No.: US 2008/0035186 A1
(43) Pub. Date: Feb. 14, 2008

(54) DISHWASHER

(75) Inventors: Dirk Wegener, Bielefeld (DE); Cornelius Wolf, Bielefeld (DE)

Correspondence Address: DARBY & DARBY P.C., P.O. BOX 770, Church Street Station, New York, NY, 10008-0770, US

(73) Assignee: MIELE & CIE. KG, Guetersloh (DE)

(21) Appl. No.: 11/829,206

(22) Filed: Jul. 27, 2007

(30) Foreign Application Priority Data
Aug. 8, 2006 (DE) 10 2006 037 324.3

(51) Int. Cl. B08B 3/04

(52) U.S. Cl. 134/143; 134/137

(57) ABSTRACT

A dishwasher includes a housing, a dish rack movably disposed in the housing, and a first and a second roller respectively disposed on opposite sides of the dish rack. The first and second rollers are configured to movably support the dish rack on respective first and second running surfaces. A respective angle of inclination of at least a respective portion of the first and second running surfaces is adjustable so as to enable the dish rack to automatically move outward from the housing.

Priority is claimed to German patent application DE 10 2006 037 324.3, filed Aug. 8, 2006, and which is hereby incorporated by reference herein.

The present invention relates to a dishwasher including a housing having one or more dish racks movably disposed therein, at least one dish rack being movably supported by rollers on opposite sides on respective running surfaces, one each per side.

### BACKGROUND

A dishwasher including a housing having one or more dish racks movably disposed therein is described, for example, in DE-OS 20 09 045. In the dishwasher described therein, the dish racks are manually moved for loading and unloading of dishes. Depending on the ease of movement provided by the rollers and guide members, a considerable handling effort may be required. This is also because said manual movement must be carried out while in a stooped position.

### SUMMARY

It is, therefore, an aspect of the present invention to provide a dishwasher in which handling is simplified in terms of movement of the dish racks.

In an embodiment, the present invention provides a dishwasher including a housing, a dish rack movably disposed in the housing, and a first and a second roller respectively disposed on opposite sides of the dish rack. The first and second rollers are configured to movably support the dish rack on respective first and second running surfaces. A respective angle of inclination of at least a respective portion of the first and second running surfaces is adjustable so as to enable the dish rack to automatically move outward from the housing.

### BRIEF DESCRIPTION OF THE DRAWINGS

The present invention will be explained in more detail below with reference to exemplary embodiments and the accompanying drawings, in which:

FIG. 1 is a side view showing a dishwasher 1 of the prior art;

FIG. 2 is a side view showing a dishwasher 1 according to the present invention, including an ejector 11;

FIG. 3 is a detail of FIG. 2 in the region of the ejector 11;

FIGS. 4 and 5 are side views of the inventive dishwasher 1, showing the ejector 11 of FIG. 2 in different operating positions;

FIG. 6 is a perspective view of a second exemplary embodiment of a dishwasher 1 according to the present invention;

FIGS. 7 through 13 are detail views showing ramp 8 of the dishwasher 1 of FIG. 6 in different positions.

### DETAILED DESCRIPTION

In accordance with the present invention, the angle of inclination of the running surfaces can be adjusted, at least in some portions, to allow the dish rack supported thereon to automatically move out. In this manner, the user no longer needs to move out the dish rack entirely manually. Rather, the dish rack can move out automatically by moving the rollers of the dish rack over the inclined track. Then, the user only needs to unload and reload the dish rack while it is supported in front of the dishwasher.

In an embodiment of the present invention, the running surfaces are in the form of inclined ramps which can be mounted on flat tracks disposed in the washing tub. This, it is possible to retrofit conventional dishwashers with such ramps.

The running surfaces or ramps are held to a wall or to the bottom of the dishwasher, it being possible to provide means for adjusting the angle of inclination of the entire track. These means may be disposed directly below the track or on the housing of the dishwasher.

Preferably, the running surfaces or ramps have hinged segments which are adjustable in inclination. Such a mechanism may be simple in construction and can be integrated into the ramps. Thus, through the adjustment made at the rear portion of the track, it is possible to produce a traveling movement of the dish rack. Depending on the installation conditions, said traveling movement can be adjusted such that the dish rack completely, or nearly completely, moves out of the interior of the dishwasher and stops in front of it in good time.

Another embodiment of the present invention provides for an actuating mechanism which can be used to move the dish rack, at least to some extent, as a door of the dishwasher is opened. The actuating mechanism may include, for example, an ejector which can be used to move the dish rack toward the extended position during or after the opening of the door. This ensures that the dish rack is only moved when the door is open. The ejector may be mechanically coupled to the door via a cable or rod. Moreover, the ejector can be mounted on the ramp.

Preferably, the tracks have at least one depression in which a roller of the dish rack can be retained, so that the dish rack is held in a predetermined position, independently of an inclination of the track. Thus, the dish rack can be latched in position by the rollers resting in the depression, so that the dish rack can, for example, be held in the retracted position, and then be moved out of the depression by an impulse from an actuating mechanism, and then to a position in front of the dishwasher.

It is also convenient if only the lowermost dish rack can be automatically moved out of the interior of the dishwasher during or after the opening of a door.

A conventional dishwasher 1 includes a housing 2 containing a washing tub 3 having dish racks disposed therein, of which only the lower rack 4 is shown. Lower rack 4 is movably supported by rollers 5 on opposite sides on tracks 6. Washing tub 3 of dishwasher 1 can be opened and closed by a hinged door 7.

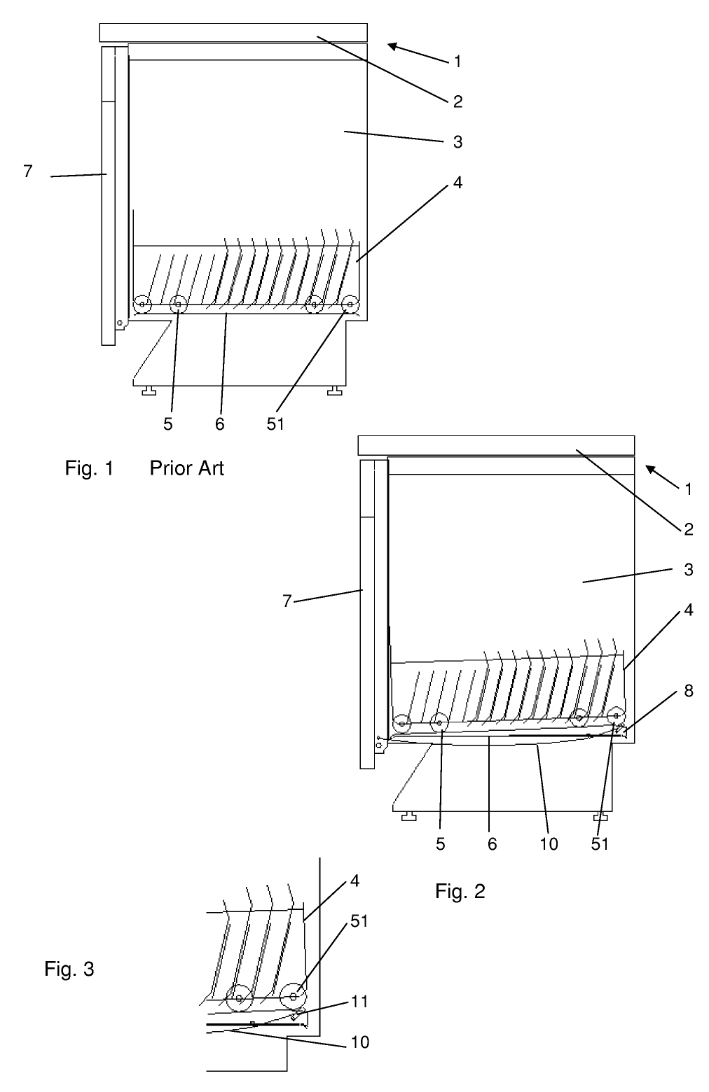

In comparison with FIG. 1, FIG. 2 and 3 show a dishwasher 1 which is designed in accordance with the present invention. In this dishwasher, rollers 5 of lower rack 4 are located on a running surface which is inclined with respect to the horizontal. For this purpose, tracks 6 have mounted thereon ramps 8 which slope downwardly toward door 7. As is clearly shown in FIG. 5, the rear end of ramp 8 has a depression 9 which fixes rear roller 51 in position, thereby holding lower rack 4 in the retracted position. Further, a cable 10 is disposed between door 5 and an actuating mechanism at the rear of lower rack 4. The actuating mechanism includes a hinged lever which serves as an ejector 11 which can be moved by cable 10.

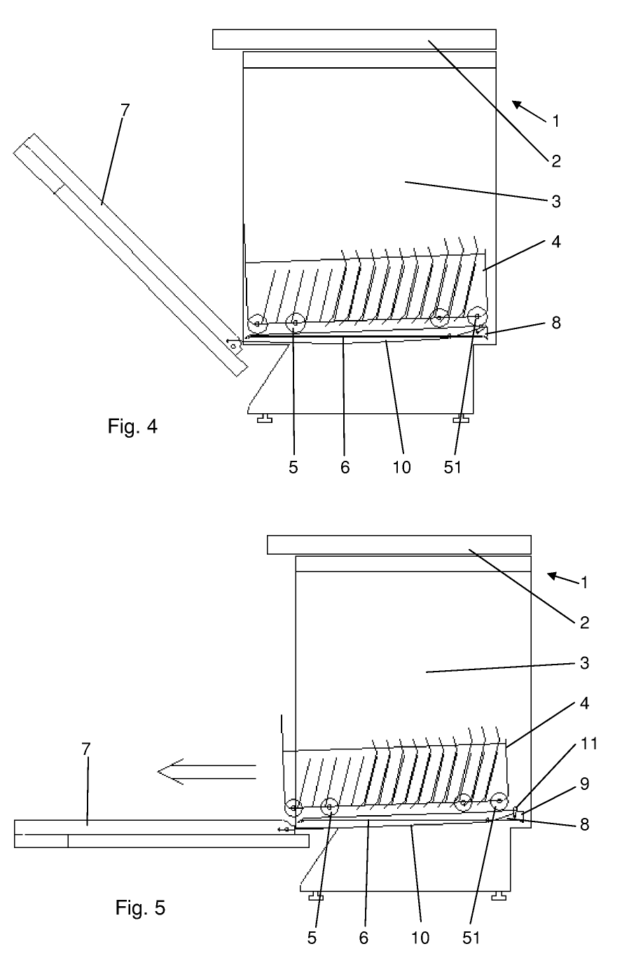

In FIG. 4, dishwasher 1 is shown with door 7 partially open, so that cable 10 is slowly tensioned, but does not yet release ejector 11. Rear roller 51 is still located in depression 9.

Only when door 7 is in the fully open position (FIG. 5), cable 10 is pulled so that the ejector 11 is pivoted. Because of this, the ejector presses against the rear roller 51 of lower rack 4, moving it out of depression 9, so that the lower rack then moves onto open door 7 due to the inclination of ramp 8. The inclination of ramp 8 and the force exerted by ejector 11 can be adjusted such that lower rack automatically moves entirely onto door 7, or nearly to this position, so that the user can then immediately begin to unload or load rack 4.

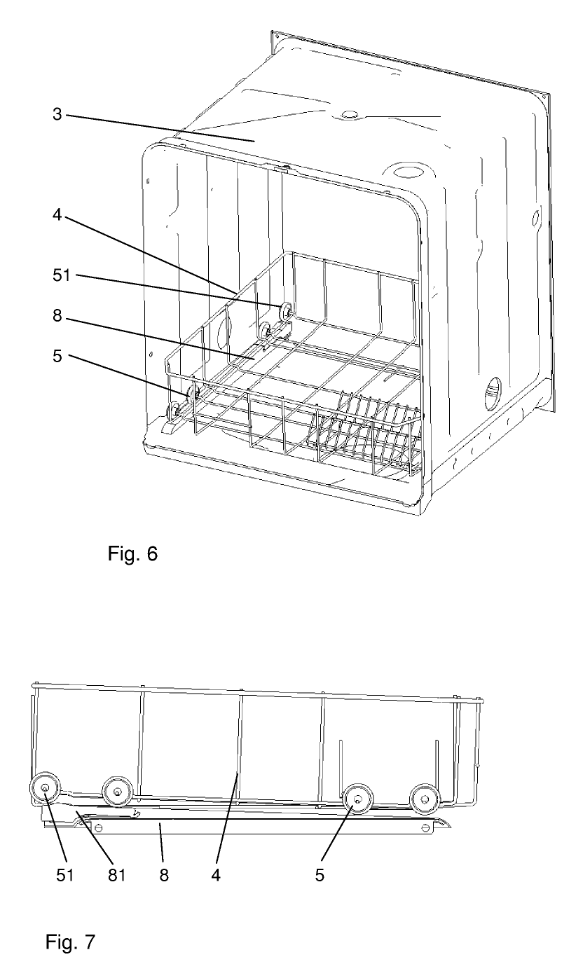

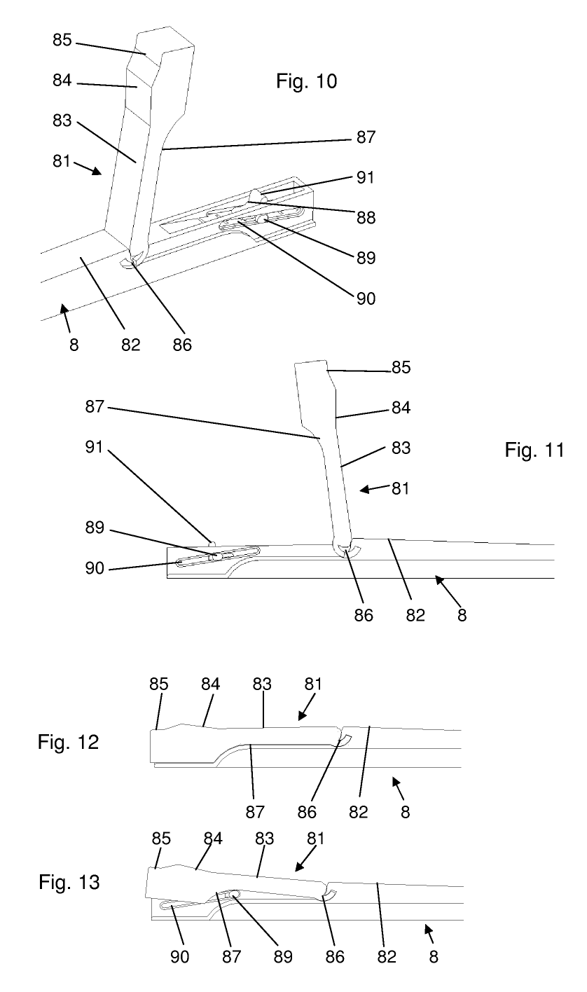

FIGS. 6 through 13 are detail views of a second embodiment of a dishwasher according to the present invention, including a washing tub 3 on the bottom of which is supported a movable lower rack 4. Lower rack 4 is provided on opposite sides with rollers 5, which in turn travel on ramps 8 mounted onto the tracks. Ramps 8 include a hinged segment 81 in the rear portion thereof.

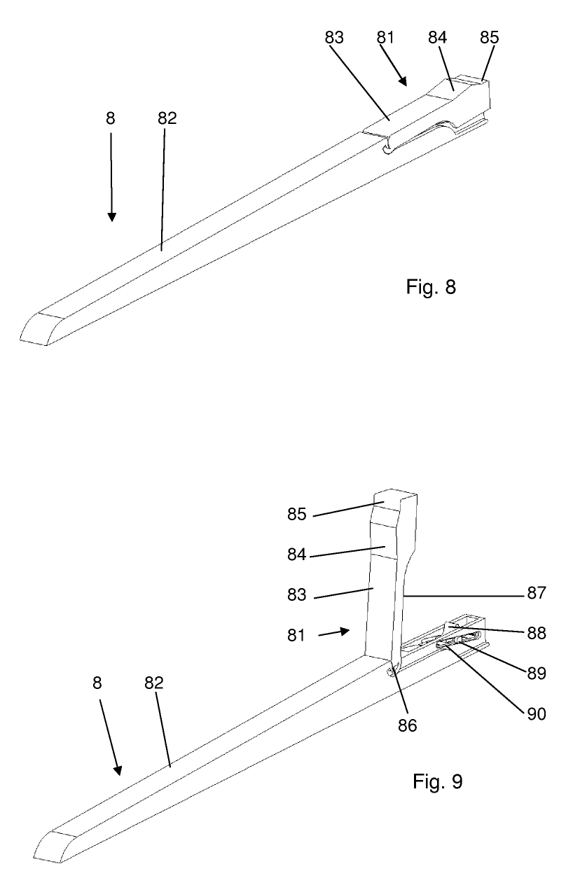

In FIG. 8, ramp 8 is shown in detail. Segment 81 is disposed such that an inclined surface 82 of the ramp is in alignment with a surface 83 of segment 81. Segment 81 includes a strip-shaped surface 83 adjacent to a slope 84, a depression 85 being formed on a rear portion of segment 81, said depression allowing rear roller 51 of lower rack 4 to rest therein so as to latch the lower rack in the retracted position. Moreover, an actuating mechanism may optionally be provided on ramp 8, such as was described in the foregoing exemplary embodiment.

In order to adjust the angle of inclination of segment 81, said segment is supported on ramp 8 in such a way that it can pivot about an axis 86, a curved guide track 87 and a slider 88 being located below segment 81 (see also FIG. 9). Slider 88 includes projecting pins 89 which are able to slide along a slot 90 which is inclined with respect to the horizontal. Slider 88 further has an upwardly projecting projection 91 on which hinged segment 81 can be supported.

In FIGS. 9, 10 and 11, segment 81 is shown in the folded up position, in which slider 88 can be moved along curved guide track 87 in order to adjust the angle of inclination of segment 81 in the folded down position.

In FIG. 12, segment 81 is folded down such that surface 83 has a smaller inclination than surface 82 of the remainder of ramp 8. In this case, the small inclination is sufficient to move lower rack 4 to the extended position when rack 4 receives an impulse from an actuating mechanism, or when the user manually pulls the dish rack across depression 85, whereupon the dish rack automatically rolls out onto door 7 due to slope 84 and the inclined surfaces 83 and 82.

If the inclination of ramp 8 is not sufficient, the user can easily adjust the inclination of segment 81 by changing the position of slider 88, so that segment 81 assumes the position shown in FIG. 13. In this position, surface 83 has a greater inclination than in the position shown in FIG. 12, so that after the dish rack has initially moved over depression 85, it moves at a greater speed due to the inclinations of slope 84 and surface 83.

In the illustrated exemplary embodiments, there is shown a mechanism for adjusting segment 81, but other embodiments are also possible. Of course, it would be possible to adjust the entire ramp 8 in inclination, or to design the larger portion of ramp 8 as a movable segment 81.

In order to overcome the retaining force caused by the positioning of roller 51 in depression 9 or 85, dish rack 4 may be initially moved also by mechanisms other than the mechanical actuating mechanism including the cable and hinged ejector 11. It is also possible to use electric drives, which allows for remote control.

The present invention is not limited to the exemplary embodiments described herein.

What is claimed is:

1. A dishwasher comprising:
a housing;
a dish rack movably disposed in the housing; and
a first and a second roller respectively disposed on opposite sides of the dish rack and configured to movably support the dish rack on respective first and second running surfaces;
wherein a respective angle of inclination of at least a respective portion of the first and second running surfaces is adjustable so as to enable the dish rack to automatically move outward from the housing.

2. The dishwasher as recited in claim 1 further comprising a washing tub disposed in the housing and a first and a second flat track disposed in the washing tub, and wherein the first running surface includes a first inclined ramp mountable on the first flat track and the second running surface includes a second inclined ramp mountable on the second flat track.

3. The dishwasher as recited in claim 1 wherein the running surfaces are attached to a wall or a bottom of the dishwasher, and further comprising an adjustment device configured to adjust a respective angle of inclination of the entire first and second running surfaces.

4. The dishwasher as recited in claim 2 wherein the running surfaces are attached to a wall or a bottom of the dishwasher, and further comprising an adjustment device configured to adjust a respective angle of inclination of the entire first and second running surfaces.

5. The dishwasher as recited in claim 2 wherein the ramps are attached to a wall or a bottom of the dishwasher, and further comprising an adjustment device configured to adjust a respective angle of inclination of the entire first and second ramp, respectively.

6. The dishwasher as recited in claim 4 wherein the ramps are attached to a wall or a bottom of the dishwasher, and further comprising an adjustment device configured to adjust a respective angle of inclination of the entire first and second ramp, respectively.

7. The dishwasher as recited in claim 1 wherein the running surfaces each include a respective hinged segment, the respective hinged segments being adjustable in inclination.

8. The dishwasher as recited in claim 2 wherein the ramps each include a respective hinged segment, the respective hinged segments being adjustable in inclination.

9. The dishwasher as recited in claim 1 further comprising a door and an actuating mechanism configured to move the dish rack as the door is opened.

10. The dishwasher as recited in claim 2 further comprising a door and an actuating mechanism configured to move the dish rack as the door is opened.

11. The dishwasher as recited in claim 3 further comprising a door and an actuating mechanism configured to move the dish rack as the door is opened.

12. The dishwasher as recited in claim 5 further comprising a door and an actuating mechanism configured to move the dish rack as the door is opened.

13. The dishwasher as recited in claim 9 wherein the actuating mechanism includes an ejector configured to move the dish rack toward an extended position during or after an opening of the door.

14. The dishwasher as recited in claim 10 wherein the actuating mechanism includes an ejector configured to move the dish rack toward an extended position during or after an opening of the door.

15. The dishwasher as recited in claim 13 further comprising at least one of a cable and a rod configured to couple the ejector to the door.

16. The dishwasher as recited in claim 14 further comprising at least one of a cable and a rod configured to couple the ejector to the door.

17. The dishwasher as recited in claim 13 further comprising a washing tub disposed in the housing and a first and a second flat track disposed in the washing tub, and wherein the first running surface includes a first inclined ramp mountable on the first flat track and the second running surface includes a second inclined ramp mountable on the second flat track, and wherein the ejector is disposed at the first or second inclined ramp.

18. The dishwasher as recited in claim 15 further comprising a washing tub disposed in the housing and a first and a second flat track disposed in the washing tub, and wherein the first running surface includes a first inclined ramp mountable on the first flat track and the second running surface includes a second inclined ramp mountable on the second flat track, and wherein the ejector is disposed at the first or second inclined ramp.

19. The dishwasher as recited in claim 2 wherein at least one of the first and second inclined ramps includes a depression configured to retain at least one of the first and second rollers so as to at temporarily hold the dish rack in a predetermined position independently of an inclined position of the respective ramp.

20. The dishwasher as recited in claim 1 further comprising a door, and wherein the dish rack is a lower rack configured to automatically move outward from the housing during or after an opening of the door.
